(19) United States
(12) Patent Application Publication
(10) Pub. No.: US 2010/0324938 A1
(43) Pub. Date: Dec. 23, 2010

(54) METHOD AND APPARATUS FOR IDENTIFYING RELATIONSHIPS IN DATA BASED ON TIME-DEPENDENT RELATIONSHIPS

(75) Inventors: Colleen Ennett, White Plains, NY (US); Pradyumna Dutta, Croton on Hudson, NY (US); N. Stephen Ober, Southboro, MA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/808,371

(22) PCT Filed: Dec. 10, 2008
(86) PCT No.: PCT/IB2008/055199

§ 371 Date: Sep. 2, 2010

Related U.S. Application Data
(60) Provisional application No. 61/017,310, filed on Dec. 28, 2007.

(51) Int. Cl. G06Q 50/00; G06F 17/30

(52) U.S. Cl. 705/3; 707/754; 707/E17.059

(57) ABSTRACT

A decision support apparatus (100) includes a subject record database (102), a temporally dependent relationship identifier (104), an event predictor (130), a coded subject record database (106), a decision support system processor (108), and a user interface (110). The temporally dependent relationship identifier processes the data in the subject record database (102) to identify temporally dependent relationships in the data. Information indicative of the identified relationships is processed by the processor (108) and presented to a user via the user interface (110).

The present application relates to the identification and presentation of time-dependent relationships in data. While it finds particular application to decision support systems in medicine, it also relates to other situations in which it is desirable to extract information indicative of relationships in data involving various subjects.

Attempts to introduce decision support systems into the clinical environment have met user resistance. For these systems to be accepted into clinical practice, they need to present information that is not already available to healthcare providers and to present that information in the context of a meaningful framework.

Recent years have also seen the increasing adoption of patient medical databases such as hospital information systems (HIS), clinical information systems (CIS), and the like. As information indicative of the status of various patients is routinely stored in these and similar systems, they ordinarily contain a trove of case-based clinical information. Unfortunately, however, it can be difficult to extract and present the information in a clinically useful manner.

Case based reasoning (CBR) paradigms have been used to retrieve past cases that are similar to a present problem, with the recalled information being reused, possibly after an adaptation step. Moreover, an approach for case representation and retrieval that takes into account the temporal dimension has been proposed. See Montani and Portinale, Accounting for the Temporal Dimension in Case-Based Retrieval: A Framework for Medical Applications, Computational Intelligence, Volume 22, Number 3/4 (2006). Nonetheless, there remains room for improvement.

Aspects of the present application address these matters and others.

In accordance with one aspect of the present application, an apparatus for identifying a relationship in subject data that includes event data indicative of an event experienced by the subject, outcome data indicative of an outcome experienced by the subject, and intervention data indicative of an intervention applied to the subject is provided. The apparatus includes a filter that temporally filters the subject outcome data and an associator that identifies an association between the event, the outcome, and the intervention as a function of the event data, the temporally filtered outcome data, and the intervention data. The associator produces an output indicative of the identified relationship.

According to another aspect, a computer readable storage medium includes instructions which, when carried out by a computer, cause the computer to carry out a method. The method includes identifying, in subject information indicative of a subject that has experienced an event, a subject outcome, and determining whether the identified outcome occurred during an outcome time interval. The method also includes associating the identified outcome and an intervention applied to the subject based on a result of the outcome time interval determination, and presenting data indicative of the association.

According to another aspect, a method includes extracting patient information from a retrospective patient record database that includes patient information for a plurality of patients, processing the patient information to identify temporally-dependent clinical relationships between events experienced by the patients, event-specific outcomes experienced by the patients, and applied event-specific treatments that are likely to have contributed to the experienced outcomes. The method also includes, for each of a plurality of the patients, storing in a coded patient record database an output indicative of an identified relationship between an event experienced by the patient, an event-specific outcome experienced by the patient, and an applied event-specific treatment likely to have contributed to the experienced outcome.

According to another aspect, an apparatus includes temporally dependent relationship identifier means for processing patient information from a patient record database that stores patient information including patient event data, applied intervention data, and patient outcome data for a plurality of patients to identify events experienced by the patients, outcomes experienced by the patients during an outcome time interval that is determined as a function of a treatment for the event, and treatments applied to the patients. The apparatus also includes a coded subject record database for storing, for each of a plurality of the patients, the identified event, the identified outcome, and the applied treatment.

According to another aspect, a computer readable storage medium contains a data structure that includes, for a plurality of subjects, event data indicative of an event experienced by the subject, outcome data indicative of an outcome experienced by the subject during an outcome interval that is determined as function of an intervention for the event, and intervention data indicative of an intervention applied to the subject. The outcomes experienced by the subjects are selected from an outcome set that describes outcomes of the event, and the interventions applied to the subjects are selected from an intervention set.

Still further aspects of the present invention will be appreciated to those of ordinary skill in the art upon reading and understanding the following detailed description.

The invention may take form in various components and arrangements of components, and in various steps and arrangements of steps. The drawings are only for purposes of illustrating the preferred embodiments and are not to be construed as limiting the invention.

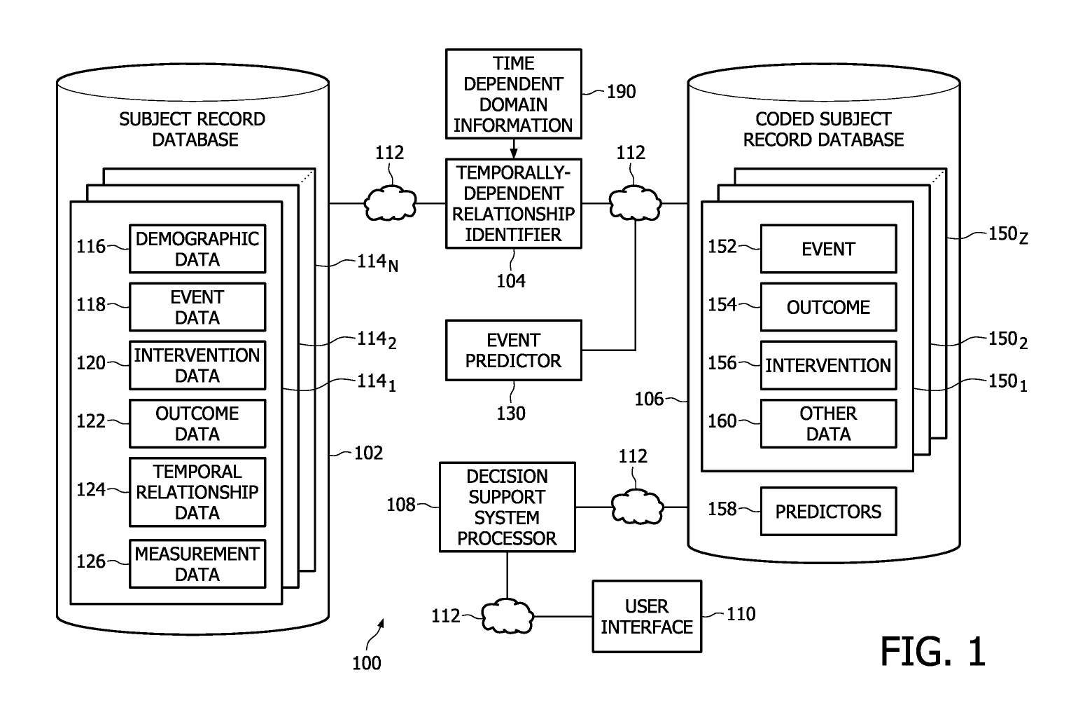

FIG. 1 depicts a decision support system.

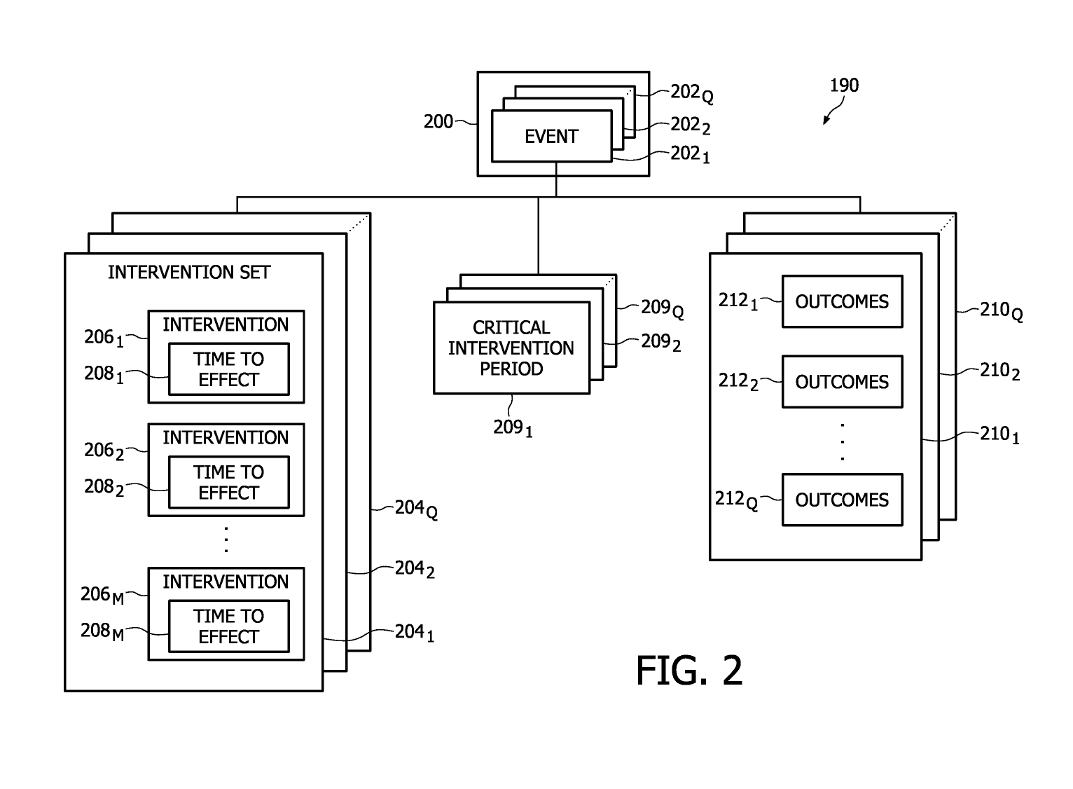

FIG. 2 depicts associations between events, outcomes, and interventions.

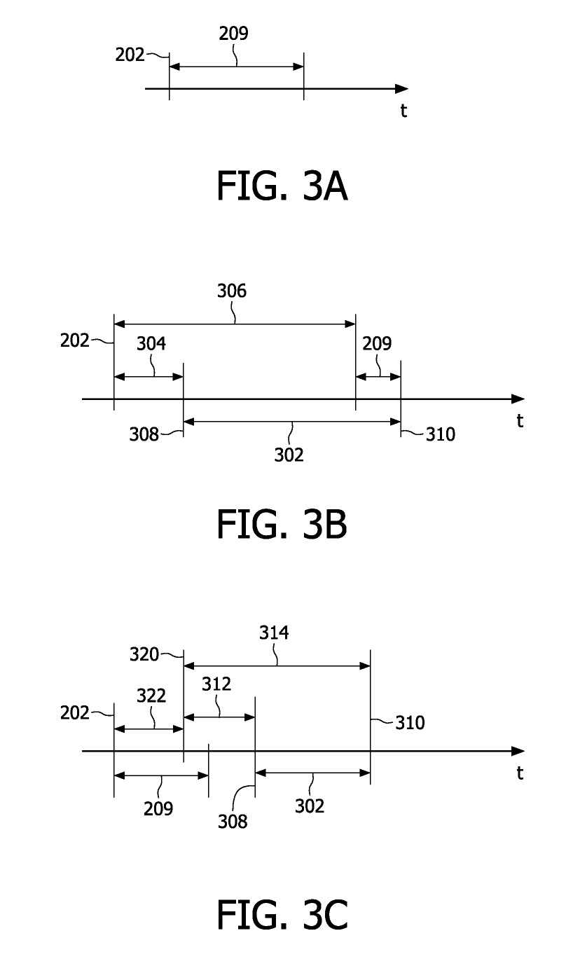

FIGS. 3A, 3B, and 3C depict temporal relationships.

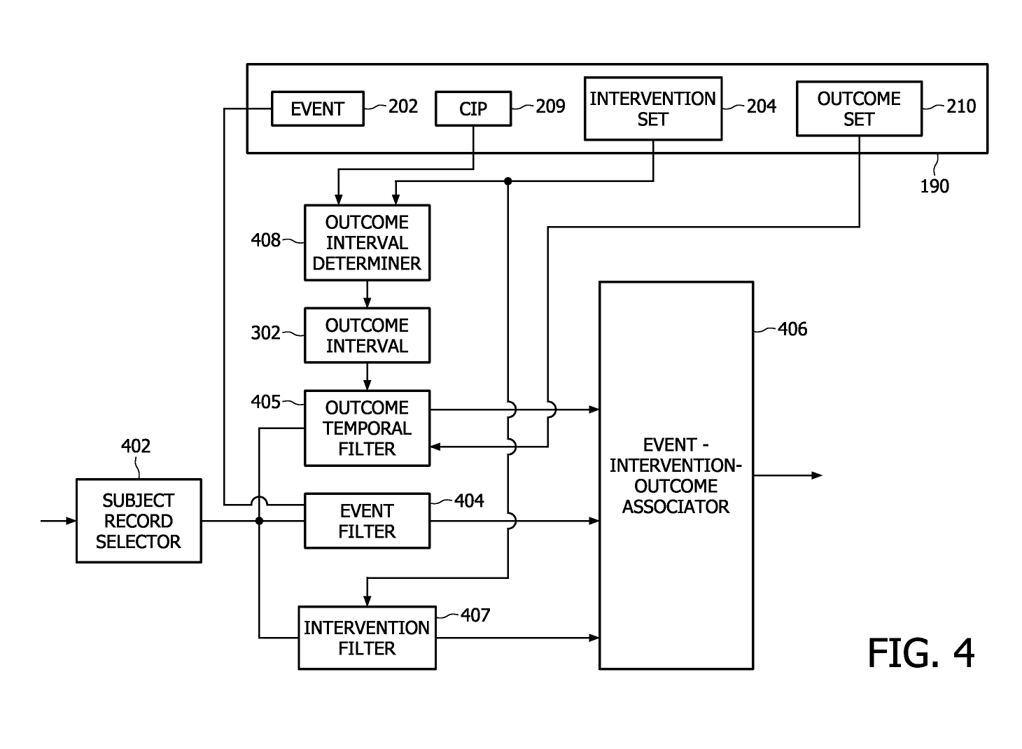

FIG. 4 depicts a temporally-dependent relationship identifier.

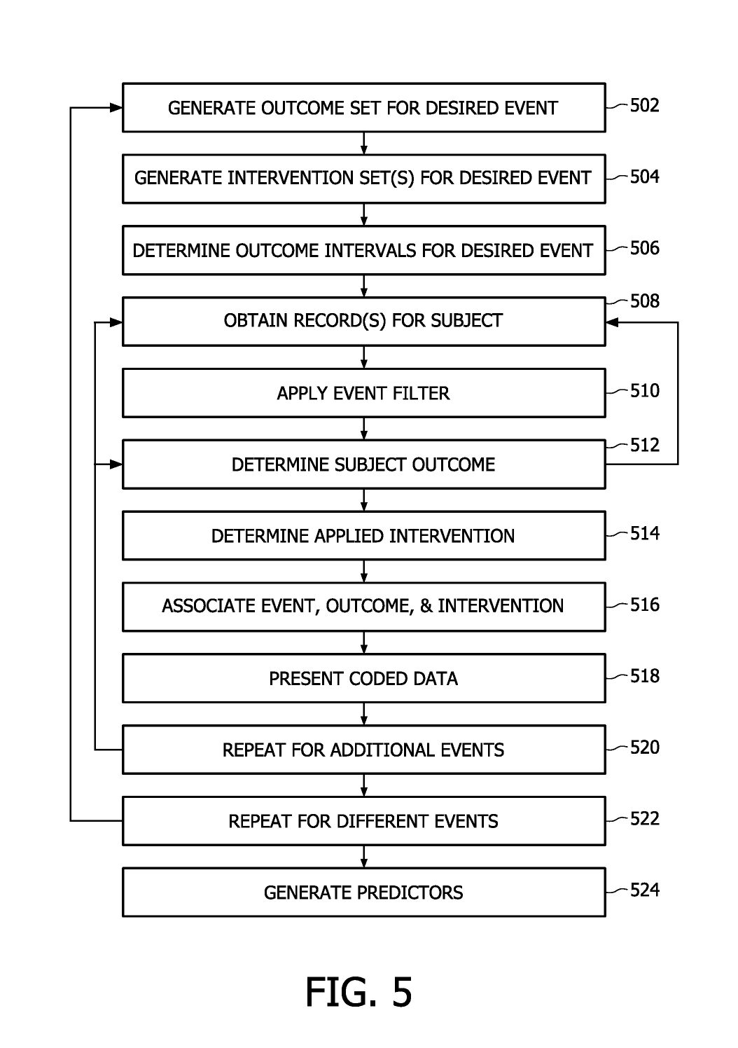

FIG. 5 depicts a method.

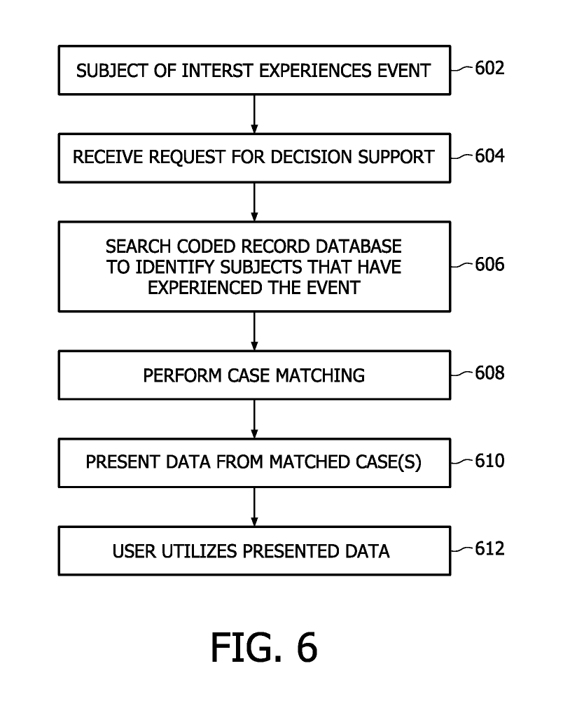

FIG. 6 depicts a method.

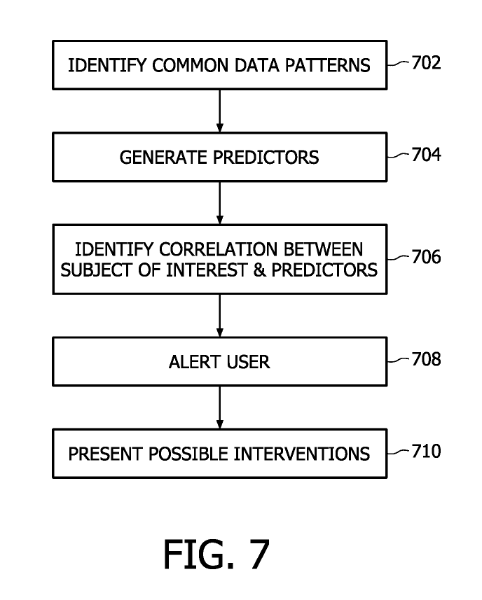

FIG. 7 depicts a method.

With reference to FIG. 1, a decision support system 100 includes a subject record database 102, a temporally dependent relationship identifier 104, a coded subject record database 106, a decision support system processor 108, and a user interface 110. As illustrated, the various components of the system 100 are located remotely from one another and communicate via a suitable communications network or networks 112 such as the internet, an intranet, or other interface. It will also be understood that one or more of the components may be located at a common location, for example as part of the same computer or on the same network.

The subject record database 102, which is typically stored on a suitable computer readable storage medium, includes retrospective subject information 114_{1-N} for each of a plurality of subjects such as human patients, inanimate objects, systems or networks (or portions thereof), or the like. The subject information 114 may be stored on or obtained from a suitable source or sources, and the formats and data structures in which the subject records are maintained is ordinarily system-specific. In a medical application, for example, the subject information 114 may include clinical data stored on a hospital information system (HIS), a clinical information system (CIS), a radiology information system (RIS), a picture archiving and communication system (PACS), laboratory or test results, physician or nursing notes, discharge summaries, image data, data from patient monitoring systems, or the like.

As illustrated, the subject information 114 includes subject demographic data 116, subject event data 118, subject intervention data 120, subject outcome data 122, temporal relationship data 124, and measurement data 126.

The subject demographic data 116 includes demographic information about the subject. Again in the medical application, the demographic data 116 may include information such as patient age, gender, disease history or state, behavioral or risk factor information, and the like.

The subject event data 118 includes data indicative of one or more adverse or other episodes experienced by the subject. In the medical example, the episodes may include one or more events requiring a treatment or other intervention by a clinician.

The subject intervention data 120 describes the intervention(s) or treatment(s) applied to the subject.

The subject outcome data 122 describes the subject's status at one or more times during the subject's history.

Subject temporal relationship data 124 describes temporal relationship(s) between one or more interventions 120 and outcomes 122. Though illustrated separately for clarity of explanation, the temporal relationship data 124 may be included in or derived from the event data 118, intervention data 120 and outcome data 122, for example where one or more of the data 118, 120, 122 includes temporal information.

The measurement data 126 includes information from qualitative or quantitative measurements of the subject. Again to the medical example, the measurement may include a blood pressure measurement, a clinician's impression of the patient state, and so on.

As will be appreciated, the subject record database 102 in many cases contains a substantial amount of retrospective, case-based data regarding events, outcomes, and interventions that was acquired in the course of routine clinical or other practice involving a number of subjects. However, some or all of the events, interventions, and outcomes involving a given subject can be essentially unrelated. Thus, a given intervention may not necessarily have helped achieve a particular outcome. Stated another way, the fact that a subject experienced a particular outcome may have little or no relationship to the event experience by the patient or to an applied treatment.

While it can be useful to understand the events, interventions, and outcomes experienced by the various subjects, a clinician, technician or other decision-maker, the relationship-if any-between these items is also an important component of an evaluation or decision-making process. For example, simply presenting information about (potentially) unrelated or unassociated outcomes, events, and interventions can in many cases overload a clinician or other user with largely spurious data. In the medical domain, the predicate question might thus be phrased as follows: might there be a reasonable expectation that there is a clinical association or relationship between an event experienced by the patient, an intervention applied to the patient, and the patient's outcome?

Thus, it can also be useful to identify and/or present information not only about similar subjects and their interventions and outcomes, but also whether the interventions following an event helped to achieve or might otherwise be related to a desired outcome. If presented to the decision-maker in the context of a decision support system, for example, the decision-maker is able to use the relationship data to evaluate possible courses of action in connection with a prospective treatment of a subject of interest.

With ongoing reference to FIG. 1, the temporally dependent relationship identifier 104 uses time-dependent domain information 190 that is based on or otherwise derived from known clinical or other relationships to perform an a priori processing of the subject information 114 to identify relevant associations in the data of the subject information 114. Stated another way, the temporally dependent relationship identifier 104 identifies associations in the subject information 114, such as relationships between events, outcomes, and interventions, with reference to the time-dependent domain information 190. Note that the information 190 may be captured and stored on a computer readable storage medium of the database 102, locally as part of the temporally dependent relationship identifier 104, or otherwise.

As will be described furthering more detail below, the temporally dependent relationship identifier 104 uses information derived from temporal relationships to produce information indicative of clinical, medical, or other associations between the events experienced by various subjects, the corresponding outcomes, and the interventions that are likely to have contributed or otherwise bear a relationship to those outcomes. Subject association data 150_{1-Z} indicative of the associations identified for the various subjects is presented to the coded subject record database 106 for further processing and/or presentation.

The coded subject record database 106, which is typically stored on a suitable computer readable medium, receives association data from the temporally dependent relationship identifier 104. The association data includes information indicative of the event-outcome-intervention relationships for a plurality of subjects. As illustrated in FIG. 1, for example, the coded subject recorded database 106 includes a plurality of subject association data 150_{1-Z} that describes an association between events 152, outcomes 154, and interventions 156 for various subjects in the subject record database 102. Also as illustrated, the subject association data 150 includes other data 160 such as some or all of the subject demographic data 116, the temporal measurement data 124, and the measurement data 126. Note that the association data may also be appended to the subject data 114 and stored in the subject record database 102.

An event predictor 130 is optionally used to analyze or mine the subject association data 150 for the various subjects to identify common data patterns preceding and/or following an event. The results of the analysis, which may be performed through data discovery techniques such as principle components analysis (PCA), artificial neural networks, domain specific knowledge or experience, or the like, are used to generate predictors 158 of future events and/or the effectiveness of possible interventions. The event predictor 130 determines predictors 158 for those subjects in the coded subject record database 106 having the same or similar event-intervention-outcome delete comment relationship. As will be appreciated, the predictors 158 can thus be associated with those interventions that are expected to provide a favorable (or conversely, an unfavorable) outcome.

In one implementation, the event predictor 130 operates a priori using the associations produced by the relationship identifier 104. In another, the event predictor operates in connection with a request for decision support.

The decision support system 108 analyzes the data from the coded patient record database 106 and presents relevant information to the clinician or other user via a suitable user interface 110 such as a computer or workstation, personal digital assistant, or the like.

An example of the time-dependent domain information 190, and more specifically temporally-dependent relationships between events, outcomes, and interventions contained therein will now be further described with reference to FIG. 2.

As illustrated, an event set 200 includes one or more events 202_{1-Q}.

Intervention sets 204_{1-Q} describe the set of interventions or treatments 206_{1-M} that are used to address corresponding events 202_{1-Q} of the event set 200. The number and nature of the interventions 206_{1-M} in a given intervention set 204 are ordinarily event-specific and are generally established on an a priori basis based on factors such as domain-specific practice and experience, expert knowledge, and the like. Associated with each intervention 206 is a time to effect 208 that describes the time needed for the intervention 206 to have a clinical or other effect on the subject. Again, the times to effect 208_{1-M} are ordinarily specific to their corresponding interventions 206_{1-M}, and are determined on an a priori basis based on domain-specific practice or experience, pharmacological or other data, expert knowledge, and the like.

Critical intervention periods (CIPs) 209_{1-Q} describe time frames following the events 202_{1-Q} in which an intervention 206 is required to prevent an adverse outcome to the subject. Again in the medical example, the CIP 209 describes for example a time period during which an intervention 206 must be applied to prevent an injury or death to the patient.

Outcome sets 210_{1-Q} describe the set of outcomes 212₁₋ₚ or subject states at one or more times following an event 202. The number and nature of outcomes 212₁₋ₚ in the outcome sets 210 are ordinarily event-specific and determined on an a priori basis based on domain-specific knowledge.

In one example, the outcome set may include at least a first outcome that describes an improvement in the subject state, a second outcome that describes a maintenance of the status quo, and a third state that describes a deterioration of the subject state. The outcomes may also be classified as desirable outcomes and undesirable outcomes, with the classification again ordinarily being event- and/or domain-specific. In the foregoing, for example, the first outcome may be classified as a desirable outcome, while the second and third outcomes may be classified as undesirable.

The foregoing relationships will now be illustrated by way of an example in which an event 202 includes an episode of acute hypotension in a human patient. Members of the intervention set 204 may include interventions 206 such as the administration of intravenous (IV) fluids, inotropic agents, β-adrenoceptor agonists, cAMP-dependent phosphodiesterase inhibitors, and α-adrenoceptor agonists. The IV fluids might have a time to effect of thirty (30) minutes, the inotropic agents may have a time to effect of ten (10) minutes, and so on. The CIP 209 for acute hypertension may be fifteen (15) minutes; otherwise the patient may suffer irreversible damage or even die. Members of the outcome set 210 may include outcomes 212 such as the return of the patient's blood pressure to a baseline level, no significant change in blood pressure, or a continued drop in blood pressure. Note that the foregoing interventions and times to effect and times are presented solely for the purpose of explanation and are not necessarily clinically accurate.

Examples of temporal relationships as may be considered by the temporally relationship identifier 104 will now be described with reference to FIGS. 3A, 3B, and 3C Turning first to FIG. 3A, a CIP 209 following the occurrence of an event 202 is illustrated. Again to the example of an acute hypertension episode, the CIP 209 may be fifteen (15) minutes.

Turning now to FIGS. 3B and 3C, an outcome time interval 302 describes a time following the occurrence of an event 202 or intervention 320 during which a subject's response can be properly assessed. Stated another way, the outcome interval 302 can be considered as time or time period during which a given outcome can be viewed as likely to have resulted from or otherwise be (clinically) related to an applied intervention, and not from extraneous or spurious factors.

A first example outcome interval 302 determination will now be described in relation to FIG. 3B. In the first example, a global outcome interval 302 is established as a function of the various interventions 206 in the intervention set 204. The outcome interval 302 is measured from the time of the event 202 and is independent of the time at which a particular intervention 206 was actually applied.

The outcome interval 302 is a function of the CIP 209 and the minimum 304 and maximum 306 of the times to effect 208 of the interventions 206 in the intervention set 204. The beginning 308 of the outcome interval 302 is bounded by the minimum (i.e., the shortest) 304 of the times to effect 208 of the interventions 206 in the intervention set 204. The end 310 of the outcome interval 302 is bounded by the sum of the maximum (i.e., the longest) 306 of the times to effect 208 of the interventions 206 in the intervention set 204 and the CIP 209. The duration of the outcome interval 302 can be expressed as follows:

OI=max(T_{E 1,2 . . . M})−min(T_{E, 1, 2 . . . M})+CIP Equation 1

where OI is the duration of the outcome interval and T_{E 1, 2 . . . M} are the times to effect 208_{1-M} of the interventions 206 in the intervention set 204.

Again to the example of acute hypotension, the minimum time to clinical effect 208 of the interventions in the intervention set 204 may be ten (10) minutes, the maximum time to clinical effect 208 of the interventions 206 may be thirty (30) minutes, and the CIP 209 may be fifteen (15) minutes. The outcome interval 302 is thus bounded by the time beginning ten (10) minutes following the occurrence of the event 202 and ending forty-five (45) minutes following the occurrence of the event 202, and has a duration of thirty-five (35) minutes.

In a second example outcome interval determination, outcome intervals 302 are established for the various interventions 206 in the intervention set 204. It will also be assumed that, for the purposes of the present example, that the time(s) at which the relevant intervention(s) 206 were applied can be determined from the patient record database 102 or is otherwise known. In the present example, the outcome interval 302 is measured from the time that a particular intervention 206 was applied.

The second example will now be described with reference to FIG. 3C for an example intervention 206ₙ of an intervention set 204. As illustrated, the outcome interval 302 is a function of the minimum 312 and maximum 314 times to effect 208 of the particular intervention 206ₙ. The beginning 308 of the outcome interval 302 is bounded by the minimum time to effect 312 of the intervention 206ₙ. The end 310 of the outcome interval 302 is bounded by the maximum time to effect 314 of the intervention 206ₙ. The duration of the outcome interval 302 can be expressed as follows:

OI=T_{E, Max} −T_{E, Min} Equation 2

where OI is the duration of the outcome interval, T_{E, Max} is the maximum time to effect 314 of the intervention 206ₙ and T_{E, Min} is the minimum time to effect 312 of the intervention 206ₙ. Note that, when applying the outcome interval 302 as determined according to the present example, interventions applied at a time later than the CIP 209 would ordinarily be identified and disregarded, particularly where the subject experienced an adverse outcome.

Again to the acute hypotension example, the application of IV fluids might be expected to have a minimum time to effect 312 of twenty (20) minutes and a maximum time to effect 314 of forty (40) minutes. The outcome interval 302 is thus bounded by the time beginning twenty (20) minutes following the intervention 320 and ending forty (40) minutes following intervention 320, and has a duration of twenty (20) minutes.

Those of ordinary skill in the art will appreciate that variations on the above-described outcome interval 302 determinations are also possible. In the second case, for example, the outcome interval 302 may be measured from the time of the event 202 by considering the time to application 322 of the intervention 206ₙ. As another example, outcome intervals 302 may be determined for one or more subsets of the interventions 206 in an intervention set 204.

The temporally dependent relationship identifier 104 will now be further described with reference to FIG. 4. As illustrated, the relationship identifier 104 includes a subject record selector 402, an event filter 404, an outcome interval determiner 408, an outcome temporal filter 405, an intervention filter 407, and an event-intervention-outcome associator 406. As described above, domain specific event data 190 describes one or more events 202 and their associated intervention sets 204, CIPs 209, and outcome sets 210.

The subject record selector 402 selects subject information 114 from the subject record database 102 for analysis.

The event filter 404 uses the domain information 190 as a resource. With reference to the domain information 190, event filter 404 filters or otherwise processes the event data 118 for the various subjects to determine if a given subject has experienced an event 202 of interest. One example of an event 202 of interest is acute hypotension. Domain information 190 defines acute hypotension as for example, a blood pressure drop of at least 20% from the last baseline in less than 15 minutes. This definition is acquired in the domain information 190 through wide acceptance of the meaning in the medical community, through case studies, or otherwise, and any combination thereof. With reference to this definition of acute hypotension in the domain information 190, event filter 404 processes event data 118 to determine if a given subject has experienced an event 202 which fits the definition of acute hypotension in the domain information 190.

The outcome interval determiner 408 uses the intervention set 204, time to effect 208, and/or the CIP 209 information to determine the outcome interval 302, for example as described above in relation to FIG. 3. Turning to the ongoing example of acute hypotension, domain information 190 also has information about relevant intervention(s), time to effect 208 and CIP 209. As explained above, members of the intervention set 204 in domain information 190 may include interventions 206 such as the administration of intravenous (IV) fluids, inotropic agents, β-adrenoceptor agonists, cAMP-dependent phosphodiesterase inhibitors, and α-adrenoceptor agonists. The IV fluids might have a time to effect of thirty (30) minutes, the inotropic agents may have a time to effect of ten (10) minutes, and so on. The CIP 209 for acute hypertension may be fifteen (15) minutes; otherwise the patient may suffer irreversible damage or even die. Again, domain information 190 has this information through the medical community, through case studies, or otherwise, and any combination thereof. Accordingly, using the domain information 190 (and more specifically, intervention, time to effect, and CIP information relevant to acute hypotension) as a reference, the outcome interval determiner 408 can determine an outcome interval 302 specific to acute hypotension through the temporal relationships and techniques discussed above in connection with FIG. 3. For example, as explained in connection with FIG. 3B, outcome interval 302 was bounded by the time beginning at 10 minutes following the event and ending 45 minutes after the event if the minimal time to clinical effect 208 is 10 minutes, the maximum time to clinical effect 208 is 30 minutes, and the CIP is 15 minutes.

Since a relevant outcome interval 302 is determined, the outcome temporal filter 405 filters or processes the outcome data 122 for the various subjects to determine if a given subject experienced an outcome 212 from the outcome set 210 during the outcome interval 302 (e.g., beginning at 10 minutes following the event and ending 45 minutes after the event). The filtering may be accomplished, for example, by searching the information 114 for a given subject to identify outcomes 212 that are members of the outcome set 210 and that occurred during the outcome interval 302. That is, in the ongoing example, outcome temporal filter 405 processes the outcome data 122 to identify outcomes 212 between the time beginning at 10 minutes following the event and ending 45 minutes after the event.

The intervention filter 407 filters or otherwise processes the intervention data 120 for the various subjects to determine if an intervention 206 (e.g., administration of intravenous (IV) fluids, inotropic agents, β-adrenoceptor agonists, cAMP-dependent phosphodiesterase inhibitors, and α-adrenoceptor agonists) from the intervention set 204 was applied to a given subject. Note that interventions applied outside the CIP 209 may be disregarded.

The event-intervention-outcome associator 406 associates the events experienced by the various subjects with the corresponding outcomes and interventions. More specifically to the illustrated example, the associator 406 produces subject association data 150 for a given subject if the subject experienced the event 202 of interest, the subject experienced an outcome 212 from the outcome set 210 during the outcome interval 302, and an intervention 206 from the intervention set 204 was applied to the subject.

Note that, while the various filters 404, 405, 407 are illustrated as operating in parallel, one or more of the filters may operate serially otherwise in a desired order. For example, the event filter 404 may identify those subjects whose records include an event of interest, the outcome temporal filter 405 may search the information 114 of the identified subjects to identify those experiencing relevant outcomes during the outcome interval 302, and so on.

Operation will now be described in relation to FIG. 5.

At 502, an outcome set is generated for an event of interest. The outcome set may be stored, for example, in a suitable memory or other computer readable storage medium.

At 504, an intervention set for the desired event is generated and may be stored in the storage medium.

At 506, the outcome interval or intervals for the desired events and/or interventions are generated, for example as described above in connection with FIG. 3. The outcome intervention information may likewise be stored in the storage medium.

At 508, some or all of the information 114 for a given subject is obtained from the subject record database 102.

At 510, the information is processed to determine if the subject experienced the event of interest. If the subject information includes multiple instances of the same event (i.e., if a patient experiences more than one episode of acute hypotension), processing may proceed with the latest of the events.

At 512, the information is processed to determine if the subject experienced an outcome from the outcome set during the outcome interval. If not, processing returns to step 508, where information 114 for another subject is obtained as desired. If so, processing continues to step 514.

At 514, the information is processed to determine if an intervention from the intervention set was applied to the subject. Note that, if multiple interventions were applied, the interventions) may optionally be deemed a single intervention.

At 516, subject association data indicative of an association between the event, the outcome, and the intervention is generated.

Note that, where the outcome interval 302 includes more than one relevant outcome determination, the choice of outcome to include in the association depends on the goals of the analysis. For example, if a goal is account for the effect of multiple applied interventions, then the temporally last outcome determination within the outcome interval can be included. If, on the other hand, a goal is to identify those interventions having the fastest response time, then the temporally first outcome determination can be included.

At 518, the subject association data is presented for storage in the coded subject record database 106.

At 520, processing is repeated as desired to catalog other instances of the event that may have been experienced by the subject and/or other subjects that have experienced the event.

At 522, processing is repeated as desired in connection with different events.

At 524, the predictor 130 determines common data patterns in those subjects having the same or a similar event-intervention-outcome relationship to generate corresponding predictors 158.

It will be appreciated that the foregoing steps may be performed in different orders and that variations are contemplated. For example, one or more of the outcome set, intervention set, and outcome interval generation steps 502, 504, 506 may be performed in different orders or concurrently for a plurality of different events. Similarly, the steps 502, 504, 506 may be performed later in the process, for example following the applied intervention determination step 514. As another example, the order of the subject outcome 512 and applied intervention determination 514 may be reversed.

As still another example, the subject records may be obtained and the filtering may be performed other than on a subject-by-subject or event-by-event basis. For example, event filters may be applied concurrently to identify each of a plurality of events; still other variations will be appreciated by those of ordinary skill in the art upon reading and understanding the present description. The predictor 130 may also be omitted.

The coded subject record data 106 may be utilized in various ways.

A first example of the application of the coded record database 106 in connection with an event driven decision support system will now be described with reference to FIG. 6.

A subject of interest experiences an event at 602. In the present example, a current patient may be experiencing an acute hypotension.

A request for decision support is received at step 604. For example, a user may request decision support in connection with a particular subject and/or event via the user interface 110. Again to the present example, a physician may request decision support as an aid to selecting a suitable treatment for application to the current patient. Note that the request for decision support need not be an explicit request. For example, the system may run behind the scenes or otherwise in the background, with operation triggered by the passage of time or one or more predicate events and the clinician or other user alerted accordingly.

At 606, the coded subject record database 106 is searched to identify those subjects that have experienced the event. The searching may be performed, for example, by the decision support system processor 108. In the present example, the coded record database 106 may be searched to identify those patients who have experienced an acute hypotension event.

At 608, a case matching or filtering step is performed to identify those of the identified subjects having characteristics that correlate to those of the subject of interest. In one implementation, the case matching is performed by the decision support system processor 108 with reference to stored demographic data 116 for the identified subjects and the demographic data for the subject of interest. In the present example, case matching may be applied to identify those of the identified patients having characteristics that correlate to the current patient.

At 610, data from the matching cases is presented via the user interface 110. In the present example, the data may be presented to the physician.

The user utilizes the data at 612. In the present example, the physician may use the data as an aid to selecting an appropriate intervention.

It will again be appreciated that the foregoing steps may be performed in different orders and that variations are contemplated.

A second example of the application of the coded record database 106 in connection with a predictive system will now be described with reference to FIG. 7.

At step 702, the data in the subject record database 102 is evaluated to identify common data patterns in subjects having the same or similar event-intervention-outcome.

At 704, the common data patterns are used to generate event predictors. More specifically, predictors are generated for various of the event-intervention-outcome relationships. In the example case of an acute hypotension, in which the intervention included the application of IV fluids and the outcome included a return to baseline, the predictors may include the occurrence of a 0.5 Celsius (C) change in temperature over a two (2) hour period, a heart rate increase of ten percent (10%) over a four (4) hour period, and respiratory rate increase of ten percent (10%) over a three (3) hour period (it again being recognized that the intervention and predictors are merely examples presented for the purposes of illustration). Thus, the presence of the predictors in a subject of interest may be used to signal the possibility of an acute hypotension event in the subject. Moreover, and as noted above, the various predictors may be associated with those interventions that are expected to lead to a favorable (or conversely, an unfavorable) outcome.

At 706, a correlation between the data pattern for a subject of interest and a generated predictor is identified, for example by the decision support processor 108. For the purposes of the present example, it will be assumed that patient data correlates to the predictors established at step 704.

At 708, the user is alerted to the possibility of a future event involving the subject, for example via the use interface 110. In the present example, the user is alerted to the possibility of an acute hypertension involving the patient.

At 710, one or more possible interventions are presented. This may be accomplished for example, substantially as described in relation to steps 608-612 of FIG. 6. Again in the present example, the presented intervention may include the application of IV fluids. As will be appreciated, such an approach can be expected to provide information about those treatments that led to favorable outcomes in a pool of patients similar to the subject of interest.

Note that, while the above-described techniques have been described in relation to an example event that includes an acute hypotension, they are also applicable to other acute and chronic conditions. They are also applicable to domains other than medicine.

As will also be appreciated by those of ordinary skill in the art, the various components and techniques described above may be implemented by way of computer readable instructions stored on suitable computer readable media. When executed by a computer, the instructions cause the computer to carry out the described techniques.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof

1. An apparatus for identifying a relationship in subject data (114) that includes event data (118) indicative of an event experienced by the subject, outcome data (122) indicative of an outcome experienced by the subject, and intervention data (120) indicative of an intervention applied to the subject, the apparatus comprising:
a filter (405) that temporally filters the subject outcome data;
an associator (406) that identifies an association between the event, the outcome, and the intervention as a function of the event data, the temporally filtered outcome data, and the intervention data and that produces an output (150) indicative of the identified relationship.

2. The apparatus of claim 1 wherein the subject is a human patient, the intervention is a medical treatment, and the associator identifies a time-dependent clinical association.

3. The apparatus of claim 1 wherein the filter filters the subject outcome data to identify outcomes (212) that are members of an outcome set (210) and that occurred during an outcome time interval (302).

4. The apparatus of claim 1 wherein the filter filters the subject outcome data according to an outcome interval (302) that is bounded on a first end by a minimum of the times to effect (208) of the interventions (206) in an intervention set (204) that includes a plurality of interventions.

5. The apparatus of claim 4 wherein the outcome interval is bounded on a second end by the sum of a critical intervention period (209) and the maximum of the times to effect of the interventions in the intervention set.

6. The apparatus of claim 1 wherein the filter filters the subject outcome data according to a time (308, 310) that is measured from the time of the intervention.

7. The apparatus of claim 1 including a subject record selector (402) that selects subject data (114) for a plurality of subjects and an event filter (404) that filters event data (118) that includes the event.

8. The apparatus of claim 1 including a patient record database (102) that includes retrospective patient demographic data (116), event data (118), intervention data (120), outcome data (122), and temporal relationship data (124) for a plurality of patients.

9. The apparatus of claim 1 including decision support system means (108, 110) for presenting the indicative of the identified association for a plurality of subjects.

10. The apparatus of claim 1 including means (130) for identifying predictors of the event.

11. A computer readable storage medium including instructions which, when carried out by a computer, cause the computer to carry out a method comprising:
identifying, in subject information (114) indicative of a subject that has experienced an event (202), a subject outcome;
determining whether the identified outcome occurred during an outcome time interval (302);
based on a result of the outcome time interval determination, associating the identified outcome and an intervention applied to the subject;
presenting data (150) indicative of the association.

12. The computer readable storage medium of claim 11 wherein the outcome time interval is a function of a minimum time to effect of a first intervention and a maximum time to effect of a second intervention.

13. The computer readable storage medium of claim 11 wherein the outcome time interval is a function of a minimum and a maximum time to effect of the applied intervention.

14. The computer readable storage medium of claim 11 wherein the method includes determining whether the identified outcome is a member of an outcome set (210) that includes a plurality of outcomes (212) and associating includes associating the identified outcome and the applied intervention based on a result of the outcome time interval determination and the outcome set membership determination.

15. The computer readable storage medium of claim 11 wherein the method includes determining whether the applied intervention is member of an intervention set (204) for the event and associating includes associating the identified outcome and the applied intervention based on a result of the outcome time interval determination and the intervention set membership determination.

16. The computer readable storage medium of claim 11 wherein the method includes determining whether the applied intervention is a member of an intervention set (204) and the identified outcome is a member of an outcome set (210), and wherein associating includes associating the event, the applied intervention, and the identified outcome if the applied intervention is determined to be a member of the intervention set, the identified outcome is determined to be a member of the intervention set, and the identified outcome is determined to have occurred during the outcome time interval.

17. A method comprising:
extracting patient information (114) from a retrospective patient record database (102) that includes patient information for a plurality of patients;
processing the patient information to identify temporally-dependent clinical relationships between events experienced by the patients, event-specific outcomes experienced by the patients, and applied event-specific treatments that are likely to have contributed to the experienced outcomes;
for each of a plurality of the patients, storing an output (150) indicative of an identified relationship between an event experienced by the patient, an event-specific outcome experienced by the patient, and an applied event-specific treatment likely to have contributed to the experienced outcome in a coded patient record database (106).

18. The method of claim 17 including:
case-matching a patient of interest and a patient in the coded record database;
presenting information indicative of the patient in the coded record database.

19. The method of claim 17 including evaluating the coded record database to identify an event predictor.

20. The method of claim 19 including:
identifying a correlation between a patient of interest and the identified predictor;
in response to the identified correlation, presenting a possible treatment for application to the patient.

21. An apparatus comprising:
temporally dependent relationship identifier means (104) for processing patient information from a patient record database (102) that stores patient information (114) including patient event data (118), applied intervention data (120), and patient outcome data (122) for a plurality of patients to identify events experienced by the patients, outcomes experienced by the patients during an outcome time interval (302) that is determined as a function of a treatment for the event, and treatments applied to the patients;
a coded subject record database (106) for storing, for each of a plurality of the patients, the identified event (152), the identified outcome (154), and the applied treatment.

22. A computer readable storage medium containing a data structure that includes, for a plurality of subjects:
event data indicative of an event (152) experienced by the subject;
outcome data indicative of an outcome (154) experienced by the subject during an outcome interval (302) that is determined as function of an intervention for the event;
intervention data indicative of an intervention (156) applied to the subject;
wherein the outcomes experienced by the subjects are selected from an outcome set (210) that describes outcomes of the event and the interventions applied to the subjects are selected from an intervention set (204).
